(19) United States
(12) Patent Application Publication
(10) Pub. No.: US 2010/0221592 A1
(43) Pub. Date: Sep. 2, 2010

(54) BATTERY PACK

(76) Inventors: Marcin REJMAN, Waiblingen (DE); Alexander Osswald, Stuttgart (DE); Rainer Glauning, Aichtal-Groetzingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/434,310

(22) Filed: May 1, 2009

(30) Foreign Application Priority Data
Feb. 27, 2009 (DE) 20 2009 002 787.2

(51) Int. Cl. H01M 2/10; H02J 7/00

(52) U.S. Cl. 429/100; 320/107

(57) ABSTRACT

The invention describes a battery pack for a handheld power tool, which can be connected replaceably to a handheld power tool and has a housing, in which a single battery cell is received in the housing.

### CROSS-REFERENCE TO RELATED APPLICATION

This application is based on German Patent Application 20 2009 002 787.2 filed Feb. 27, 2009.

### BACKGROUND OF THE INVENTION

1. Field of the Invention

The invention relates to a battery pack, in particular for a handheld power tool.

2. Description of the Prior Art

From the prior art, handheld power tools with a plurality of battery cells are known, in which the battery cells are combined into a battery pack. The battery pack is either built fixedly into the housing, for instance into the handle, of the handheld power tool or is connected replaceably to the housing of the handheld power tool. For example, spare battery packs are mounted on the lower end of the handle of the handheld power tool and form a base on which the tool can stand.

### ADVANTAGES AND SUMMARY OF THE INVENTION

The battery pack of the invention has the advantage that a battery pack with only a single battery cell is also available as a spare battery pack. Thus a handheld power tool can for instance be provided with two spare battery packs according to the invention, so that working with the handheld power tool is possible even if one battery pack has to be set aside for charging in a charger. In conventional handheld power tools, which have a fixedly built-in battery pack with only one battery cell, this is not possible, since the battery pack cannot be removed from the handheld power tool for charging. The spare battery pack also has the advantage that a defective battery pack can simply be replaced.

A spare battery pack with only one battery cell has the further advantage that it is comparatively small and compact, so that it can be disposed in the handle of a handheld power tool, for instance; the battery pack with the battery cell is received in the longitudinal direction inside the handle and does not, as in conventional battery packs, form a base on the lower end of the handle for the tool to stand on.

At the same time, for a single-cell spare battery pack, there is difficulty in accommodating the components required for the battery pack in a small space, so that the housing of the battery pack is only insignificantly larger than the individual battery cell itself. On the one hand, the diameter of the battery pack housing should not be substantially greater than the diameter of the battery cell itself; that is, the housing of the battery pack should correspond essentially to the diameter of the battery cell, plus the thickness of the wall of the housing. On the other, the housing of the battery pack should not be substantially longer than the battery cell itself. The battery cell itself is cylindrical in particular, but may have other shapes instead. Especially in the case of a lithium ion battery cell, however, besides the battery cell itself still other components, such as a circuit board with electronic components, lines, and a temperature sensor, are necessary for the reliable, safe operation of the battery cell and must therefore be accommodated in the housing of the battery pack. The components are preferably disposed in the region of one face end of the battery cell, where they occupy as little space as possible, so that in the region of the components, the housing does not have a larger diameter than in the region of the battery cell itself.

In addition, at least one locking mechanism and at least one unlocking mechanism are provided on the housing, and the housing, locking mechanism and unlocking mechanism are embodied in one piece. This is advantageous because in this way, the structural size of the housing of the battery pack of the invention is not enlarged unnecessarily by the locking mechanism and the unlocking mechanism. The locking mechanism is preferably a pawl, while the unlocking mechanism is preferably a self-resilient actuation tab.

The housing is preferably constructed in two parts, such that a first housing part is embodied as cup-shaped and receives the battery cell completely, while a second housing part is embodied in caplike form covers and end of the first housing part, to close an open end of the first housing part off. In particular, the at least one locking mechanism and the at least one unlocking mechanism are embodied in one piece with the first, cup-shaped housing part.

The housing of the battery pack preferably comprises plastic. The at least one locking mechanism, preferably two pawls, and the at least one unlocking mechanism, preferably two self-resilient actuation tabs, are injection-molded in one piece onto the cup-shaped housing part of the housing.

The battery cell of the spare battery pack of the invention is preferably a lithium ion cell. The cathode material of the battery cell may be constructed for example from mixed oxides or on the basis of lithium iron phosphate (LiFePO₄) or lithium manganese phosphate (LiMnPO₄) or (LiVPO₄F), or a mixture of these cathode materials.

Moreover, the battery pack of the invention preferably has coding mechanism that describe the number of battery cells. Moreover, the battery pack preferably has coding mechanism which describe the cathode material of the battery cell. The battery pack furthermore preferably includes coding mechanism which describe the capacity of the battery cell. Thus the information that only one battery cell is present, and/or information as to which type of battery cell is present, and/or information as to which capacity the battery cell has, can be sent by the battery to a charger or a handheld power tool, for instance. It can thus be prevented that the battery pack will be connected to a device, such as a charger or a handheld power tool, for which the battery pack is not suitable. As the coding mechanism, electronic elements are suitable, such as a coding resistor or a data store, or mechanical elements, such as an additional contact elements, a switch elements, or a coding pin for interrupting a light gate.

A handheld power tool with a battery pack according to the invention forms a further subject of the invention. The handheld power tool may for instance be a cordless screwdriver. The term handheld power tool in the sense of the present invention is considered to cover garden tools as well, such as electrically powered shears, such as grass shears, lopping shears, and so forth.

Preferably, the battery pack can be introduced longitudinally into the handle of the handheld power tool. For that purpose, the housing of the handheld power tool has a receptacle on its lower end for the battery pack, so that the battery pack can be slipped into the handle from below. Once the battery pack has locked to the housing of the handheld power tool, the battery cell is located in the battery pack inside the handle of the handheld power tool.

A charger for a battery pack of the invention forms a further subject of the invention.

In a preferred embodiment, the charger is designed such that it can charge not only the spare battery pack of the invention having a single cell but also, instead of that spare battery pack with one battery cell, a spare battery pack with two or more battery cells as well.

The charger is preferably equipped with a mechanism that correspond with a coding mechanism of the battery pack. The coding mechanism of the battery pack preferably describe the number and/or the cathode material of the battery cell contained in the battery pack. The mechanism of the charger that correspond with the coding mechanism of the battery pack are accordingly capable of detecting the number and/or the cathode material of the battery cell contained in the battery pack and of selecting a suitable charging process, characterized for instance by a defined concluding charging voltage.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows an embodiment of a spare battery pack of the invention in longitudinal section;

FIG. 2 shows an embodiment of the charger of the invention in perspective; and

FIG. 3 shows an embodiment of a handheld power tool of the invention in perspective.

### DESCRIPTION OF THE PREFERRED EMBODIMENTS

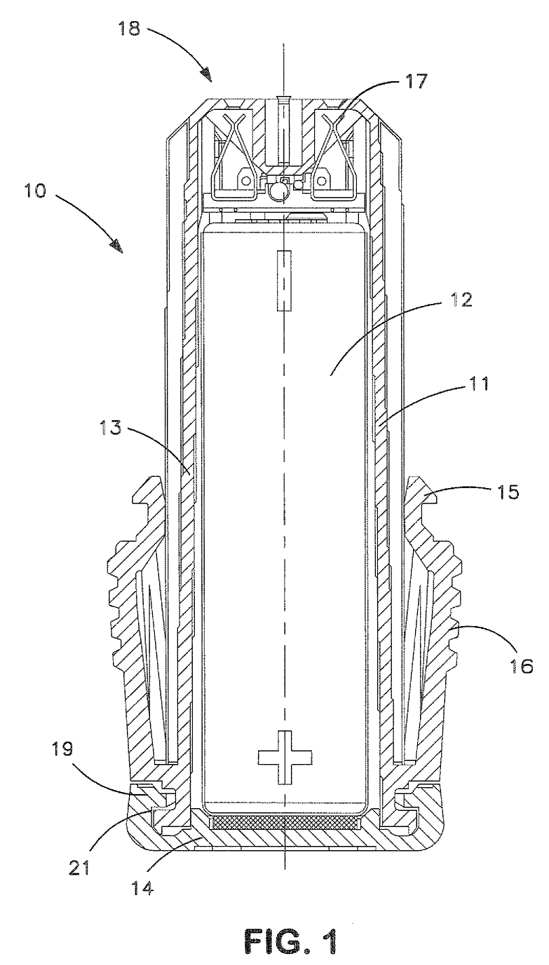

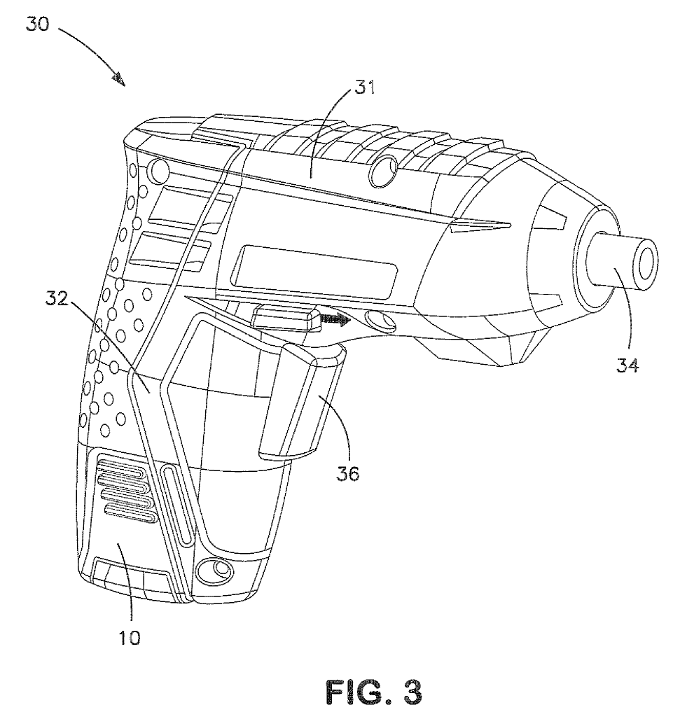

In FIG. 1, an embodiment of a battery pack 10 of the invention, with a single battery cell 12, is shown. The battery cell 12 is a lithium ion cell. It is cylindrical. The single-cell spare battery pack 10 is suitable as a voltage source for a handheld power tool 30, such as a cordless screwdriver (FIG. 3). The battery pack 10 has a housing 11 of plastic. A single battery cell 12 is received in the housing 11. The housing 11 is constructed in two parts. A first housing part 13 is embodied in cup-shaped fashion and receives the battery cell 12 completely. A second housing part 14 is embodied in caplike fashion and covers the first housing part 13. To that end, the housing part 14 is provided with that engage corresponding detent recesses 21 of the housing part 13.

It can be seen from FIG. 1 that the diameter of the housing 11 of the battery pack 10 is not substantially greater than the diameter of the battery cell 12 itself. The diameter of the housing 11 is essentially equivalent to the diameter of the battery cell 12, plus the thickness of the wall of the housing 11, over the entire length of the battery pack 10. On the upper face end of the battery cell 12 in FIG. 1 as well, in the region of which, among other elements, means 17 for making electrical contact of the battery pack 10 and a handheld power tool 30 (see FIG. 3) are provided, the diameter of the housing 11 is essentially equivalent to the diameter of the battery cell 12. Thus the interface 18 of the battery pack 10 is accommodated on an area that corresponds essentially to the diameter of the battery cell 12.

The housing 11 is equipped with locking means 15 in the form of pawls and with unlocking means 16 in the form of self-resilient actuation tabs. The first, cup-shaped housing part 13 is embodied in one piece with the locking means 15 and the unlocking means 16, in that the locking means 15 and unlocking means 16 are injection-molded onto the housing part 13. The locking means 15 on locking to a housing of a handheld power tool engage corresponding detent grooves (not shown).

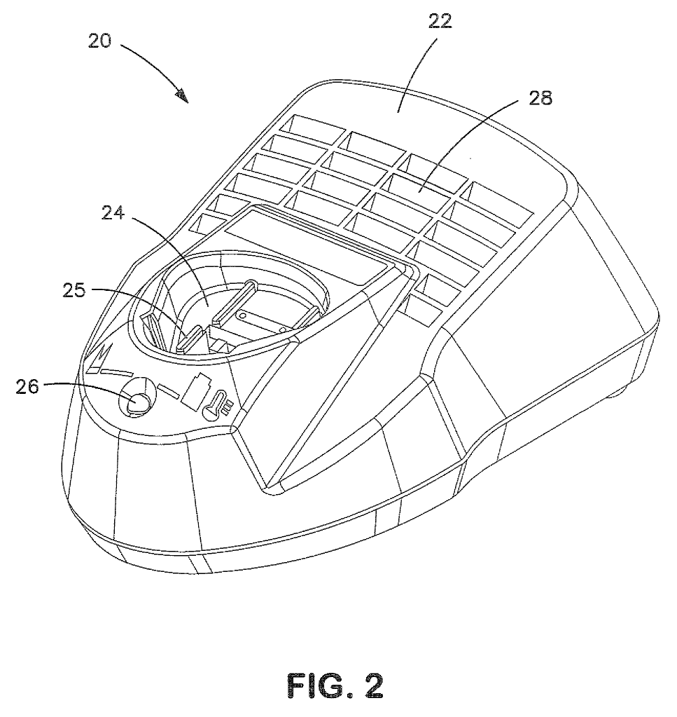

In FIG. 2, a charger 20 for recharging a spare battery pack of the invention is shown. The charger 20 is especially suitable for charging a single-cell spare battery pack 10 of FIG. 1. The charger 20 includes a housing 22 with a receptacle 24 for a spare battery pack. In the region of the receptacle 24, means 25 are provided for putting the battery pack into electrical contact with the charger 20. The charger is equipped with means that correspond to coding means of the battery pack. The coding means of the battery pack preferably describe the number or the cathode material of the battery cell contained in the battery pack. The charger is therefore capable of detecting the number of battery cells in the battery pack as well as the type of battery cells, and especially whether the battery cell is a lithium ion cell.

A charge state display 26 is also disposed on the housing 22 of the charger 20. Venting slits 28 are also provided.

FIG. 3, as one embodiment of a handheld power tool 30 of the invention, shows a cordless screwdriver. The housing 31 of the handheld power tool 30 has a handle 32. The single-cell spare battery pack 10 is received in the longitudinal direction in the handle 32. For that purpose, the housing 31 of the handheld power tool 30 has a receptacle on its lower end for the battery pack 10, so that the battery pack 10 can be introduced into the handle 32 from below. The battery pack 10 locked to the housing of the handheld power tool 30 is received essentially completely in the handle 32. In particular, the battery cell itself is located inside the handle 32 of the handheld power tool 30.

The handheld power tool 30 is furthermore equipped with a tool receptacle 34, for instance for screwdriver bits, and with a pushbutton 36 for switching the handheld power tool 30 on and off.

The foregoing relates to preferred exemplary embodiments of the invention, it being understood that other variants and embodiments thereof are possible within the spirit and scope of the invention, the latter being defined by the appended claims.

We claim:

1. A battery pack for a handheld power tool, which can be connected replaceably to a handheld power tool and which has a housing, wherein a single battery cell is received in the housing.

2. The battery pack as defined by claim 1, wherein the battery cell is a lithium ion cell.

3. The battery pack as defined by claim 1, wherein the battery cell is a cell based on lithium iron phosphate or lithium manganese phosphate as cathode material, or based on a mixture of these cathode materials.

4. The battery pack as defined by claim 1, wherein the battery pack has coding means which describe the number of battery cells.

5. The battery pack as defined by claim 2, wherein the battery pack has coding means which describe the number of battery cells.

6. The battery pack as defined by claim 3, wherein the battery pack has coding means which describe the number of battery cells.

7. The battery pack as defined by claim 1, wherein the battery pack has coding means which describe the cathode material of the battery cell.

8. The battery pack as defined by claim 2, wherein the battery pack has coding means which describe the cathode material of the battery cell.

9. The battery pack as defined by claim 3, wherein the battery pack has coding means which describe the cathode material of the battery cell.

10. The battery pack as defined by claim 6, wherein the battery pack has coding means which describe the cathode material of the battery cell.

11. The battery pack as defined by claim 1, wherein the battery pack has coding means which describe the capacity of the battery cell.

12. The battery pack as defined by claim 1, wherein the housing has at least one locking means, in particular a pawl, and at least one unlocking means, in particular a self-resilient actuation tab, and the housing, locking means and unlocking means are embodied in one piece.

13. The battery pack as defined by claim 1, wherein the housing is embodied in two parts, and a first, cup-shaped housing part receives the battery cell entirely and is closed off by a second, cap-shaped housing part.

14. The battery pack as defined by claim 8, wherein the first housing part and the at least one locking means and the at least one unlocking means are embodied in one piece.

15. A handheld power tool having a battery pack as defined by claim 1.

16. The handheld power tool as defined by claim 10, wherein the battery pack is capable of being introduced in the longitudinal direction into the handle of the handheld power tool.

17. A charger for a battery pack as defined by claim 1.

18. The charger as defined by claim 17, wherein instead of a spare battery pack with one battery cell, a spare battery pack with two or more battery cells can be charged.

19. The charger as defined by claim 17, wherein the charger has means which correspond with coding means of the battery pack.

20. The charger as defined by claim 18, wherein the charger has means which correspond with coding means of the battery pack.
